(19) United States
(12) Patent Application Publication
(10) Pub. No.: US 2023/0416655 A1
(43) Pub. Date: Dec. 28, 2023

(54) EXTRACTOR CLEANING AGENT

(71) Applicant: Michael J. McKINNON-DANE, Dover, NH (US)

(72) Inventor: Michael J. McKINNON-DANE, Dover, NH (US)

(21) Appl. No.: 18/342,180

(22) Filed: Jun. 27, 2023

Related U.S. Application Data
(60) Provisional application No. 63/356,314, filed on Jun. 28, 2022.

(51) Int. Cl. C11D 11/00; C11D 1/72; C11D 3/33; C11D 3/20; C11D 3/40; D06F 35/00

(52) U.S. Cl. CPC C11D 11/0017; C11D 1/72; C11D 3/33; C11D 3/2079; C11D 3/40; D06F 35/006

(57) ABSTRACT

A detergent for use in turnout gear extractors is provided. The detergent includes coloring for easy identification and is of low viscosity compared to other options. The detergent aids in compliance of NFPA 1851. The detergent is capable of removing dangerous residues from turnout gear without damaging plastic lenses that may be on the gear.

### BACKGROUND

First responders often wear turnout gear designed to protect them against heat, smoke and chemicals. Many combustion products and other chemicals that can be encountered by first responders are not only toxic but can cause cancer or result in other long-term health effects. Thus, for protecting the health of first responders it is important that these compounds are washed from turnout gear before it is used again.

### BRIEF DESCRIPTION OF THE DRAWINGS

Features and advantages of embodiments of the claimed subject matter will become apparent as the following Detailed Description proceeds, and upon reference to the Drawings, in which:

FIG. 1 is a table showing removal efficiency of one embodiment of the cleaning agent in compliance with NFPA 1851.

Although the following Detailed Description will proceed with reference being made to illustrative embodiments, many alternatives, modifications, and variations thereof will be apparent in light of this disclosure.

### DETAILED DESCRIPTION

As noted above, turnout gear is designed specifically to protect first responders from chemicals that they may encounter in the field. These chemicals include combustion products that may be harmful if breathed or if they come into contact with the skin. As such, turnout gear is designed to repel or adsorb many of these chemicals so that they don't reach the lungs or skin of the first responder. As many of these chemicals may be harmful in very low concentrations it is important that they are removed from the turnout gear as completely as possible before the gear is to be used again.

Harmful chemicals encountered by first responders may vary in nature and can range from very water soluble to entirely insoluble. This means that typical laundering conditions may not be able to reduce the levels of harmful chemicals to required concentrations. The National Fire Protection Association (NFPA) provides concentration limits for a variety of substances in “NFPA 1851-2020: Standard on Selection, Care, and Maintenance of Protective Ensembles for Structural Fire Fighting and Proximity Fire Fighting,” which is hereby incorporated by reference herein.

Disclosed herein is an aqueous based cleaning agent to be used with extractor washing machines for the laundering of turnout gear. The cleaning agent is effective at removing anionic, cationic and non-ionic compounds to levels that comply with NFPA 1851. The cleaning agent is effective against water soluble and water insoluble substances while not damaging turnout gear components such as fibers, coatings and plastic lenses. The low viscosity of the cleaning agent allows it to be used in a variety of extractor washing machines, and a coloring agent enables the cleaning agent to be monitored in tubes and lines. The cleaning agent can be used with a variety of personal protective equipment (PPE) as well as with firefighter turnout gear.

The cleaning agent can have a pH that is close to neutral, avoiding damage to fibers that can be caused by detergents at elevated pHs. For example, the pH of the cleaning agent can be between 6.5 and 8.0, between 7.0 and 8.0 or between 7.0 and 7.5. The cleaning agent can include an emulsifier such as a linear ethoxylate, and in some cases a C₁₂ to C₁₅ linear ethoxylate, or a mixture of C₁₂-C₁₅ linear ethoxylates. One such material is BIO-SOFT® N25-3, available from Stepan. The cleaning agent can also include one or more chelates. The one or more chelates can be selected from salts of organic acids, and in particular, salts of organic acids that include a nitrogen atom, such as tertiary amines. Examples include salts of glutamic acid such as glutamic acid, N, N-diacetic acid, tetrasodium salt (GLDA). GLDA is available from Nouryon and is sold under the mark DISSOLVINE GL-47-S. The cleaning agent also includes one or more fatty acids that can be saponified during the production process. These include, for example, coconut fatty acid. The colorant can be, for example, an aqueous soluble colorant that is low staining. It may be a liquid that is infinitely soluble in water and can be a non-dye and/or a non-pigment. Examples include L85000 LIQUITINT® PATENT BLUE, available from Milliken.

One embodiment of producing the cleaning agent is as provided below. All components are wt/wt unless otherwise noted.

To 85.3 parts of hot water (75° C.) is added 2.4 parts of sulfonic acid and 0.65% of coconut fatty acid. After dissolution of these components, sodium hydroxide is added to raise the pH to 7.5. This is typically about 0.65 parts of concentrated sodium hydroxide. To this solution is added 0.2 parts sodium bicarbonate and 0.5 parts sodium benzoate. The mixture is stirred with a paddle mixer until all components are dissolved. To this solution is added 7 parts BIOSOFT 25-7, 0.75 parts sodium citrate, 0.75 parts propylene glycol, 1.5 parts lauramine oxide and 0.3 parts DISSOLVINE GL-47. After the solution is thoroughly mixed, citric acid is added to lower the pH to 7.25. At this point a colorant such as LIQUITINT BLUE is added until the desired intensity of color is achieved. The resulting cleaning agent has a viscosity less than 10,000, less than 5,000, less than 2500 or less than 1000 cS.

### Example—

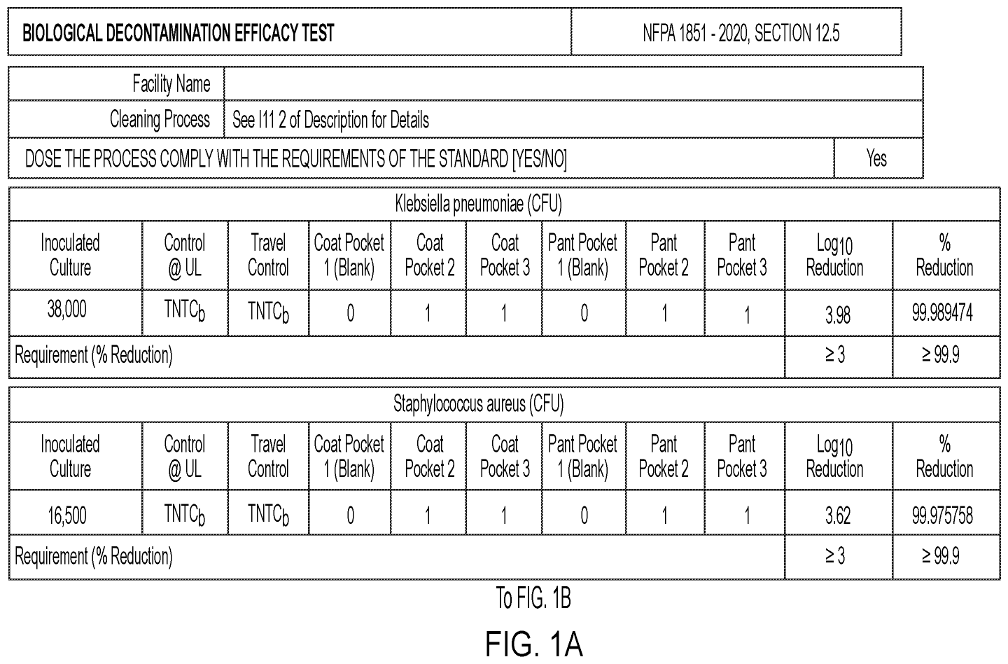

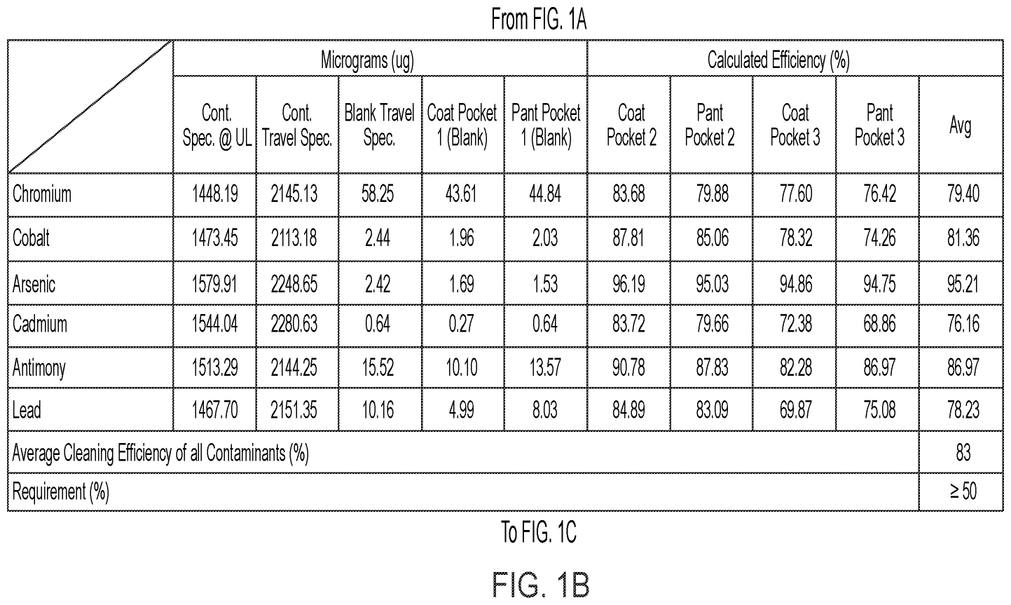

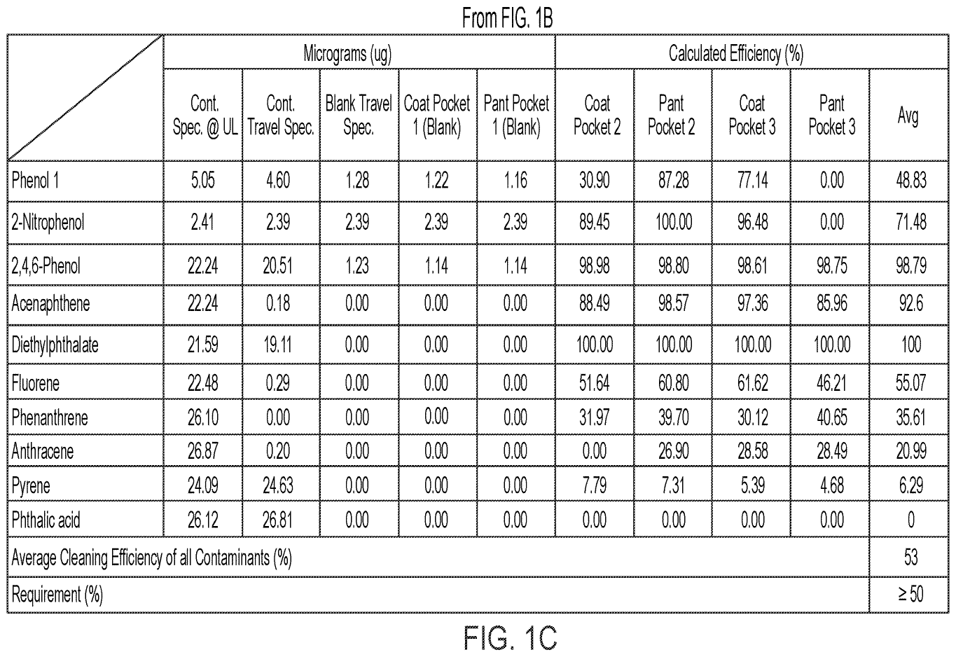

FIG. 1 illustrates results from a test performed by an independent tester in compliance with NFPA 1851 Verification requirements. Results of the test are provided in the table shown. The results indicated successful removal of biological pathogens, heavy metals, and organic compounds such as polycyclic aromatic hydrocarbons, phenols and phthalates. The extractor washer procedure also showed no damage to the fibers of the substrate and no damage to plastic lenses. The extractor process was completed at essentially neutral pH and at a relatively cool temperature of less than 50° C.

Numerous specific details have been set forth herein to provide a thorough understanding of the embodiments. It will be understood in light of this disclosure, however, that the embodiments may be practiced without these specific details. In other instances, well known operations and components have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

What is claimed is:

1. An extractor cleaning agent comprising:
a chelation agent;
a detergent including a fatty acid; and
a colorant, wherein the detergent exhibits a pH of greater than 7.0 and less than 8.0.

2. The extractor cleaning agent of claim 1 wherein the cleaning agent exhibits a viscosity of less than 5000 cS.

3. The extractor cleaning agent of claim 1 wherein the detergent comprises a linear alcohol ethoxylate.

4. The extractor cleaning agent of claim 1 wherein the chelation agent comprises a salt of a diacetic acid.

5. The extractor cleaning agent of claim 4 wherein the chelation agent comprises glutamic acid, N,N-diacetic acid, tetrasodium salt.

6. The extractor cleaning agent of claim 1 wherein the colorant is a non-dye and a non-pigment.

7. A method of cleaning contaminants from turnout gear, the method comprising:
placing the turnout gear in an extractor washing machine;
adding a cleaning agent having a pH of greater than 7.0 and less than 8.0, the cleaning agent including a chelation agent, a detergent including a fatty acid, and a colorant;
adding water to the extractor washing machine and extracting contaminants from the turnout gear while limiting the water temperature to less than 50° C.;
monitoring the cleaning agent by assessing tubes and/or lines for the colorant; and
cleaning the turnout gear to comply with NFPA 1851.

8. The method of claim 7 wherein any plastic lenses on the turnout gear are not damaged in the cleaning process.
